(19) United States
(12) Patent Application Publication
(10) Pub. No.: US 2003/0167565 A1
(43) Pub. Date: Sep. 11, 2003

(54) Motorized body scrubber

(76) Inventor: Akifumi Yoshida, San Rafael, CA (US)

Correspondence Address: AKI YOSHIDA, 19 LATHAM ST., SAN RAFAEL, CA, 94901, US

(21) Appl. No.: 10/092,274

(22) Filed: Mar. 7, 2002

(51) Int. Cl. A47K 7/02; B60S 3/00

(52) U.S. Cl. 4/606; 15/21.1; 15/97.1

(57) ABSTRACT

A motorized body scrubber is invented to scrub from the neck to the toes easily, safely and non-strenuously for anyone, especially for disabled users.

The body scrubber is comprised of a motorized rotating scrubber, a wall mounted scrubber traveling rail and a motorized scrubber height changer. The scrubber is made of sponge. The scrubber is shaped such that the large and small, flat or contoured, or crevices may be scrubbed. The height of the rotating scrubber can be changed at will anytime even during scrubbing. The scrubber angle is also manually adjustable for scrubbing feet or stowage. An additional rinse showerhead and soap dispenser travels vertically with the scrubber.

A washcloth scrubber pad may be used. The scrubber pad can form a pocket for a solid soap bar, thereby, eliminating the frequent liquid soap applications on the scrubber. In addition, the scrubber travel rail may be used as a safety rail in the shower stall or the bath.

### CROSS REFERENCE TO RELATED APPLICATIONS

Not applicable

### BACKGROUND

1. Field of Invention

This invention relates to a motorized body scrubber for scrubbing body specifically for scrubbing back, sides, front and underarms of the dorsal portion and thighs, legs, feet and other crevices of a person in the shower stall or the bath.

2. Description of Prior Art

There are many patents granted to the powered back or body scrubbers. U.S. Pat. No. 5,345,640 to Goss in 1994 has the plurality of brushes, water spray and liquid soap dispensing nozzles at a fixed position.

U.S. Pat. No. 5,239,712 to Kinder in 1993 has multiple powered brushes of different sizes mounted on the casing fixed on the wall. U.S. Pat. No. 4,704,756 to Williams in 1987 illustrates water powered reciprocating brushes. U.S. Pat. No. 4,432,113 to Gouge in 1984 illustrates that the motorized scrubber apparatus is mounted on a counter top.

U.S. Pat. No. 4,008,503 to Tharp in 1977 has a vertical brush mounted on a manually height adjustable back plate. The plate height is fixed during scrubbing operation. U.S. Pat. No. 2,730,737 to Herman in 1956 shows a scrubber that the height can be manually adjustable by means of a screw and worm gear drive.

All the body or back scrubbers heretofore known suffers from a number of disadvantages:

a) The scrubber is fixed at a height or cannot be changed easily during the scrubbing without interruption.

b) Even for the scrubber apparatus that is possible to adjust the scrubber height, it is done so manually.

c) Even for the manual height adjustment, the user needs to turn the body to face the scrubber apparatus to adjust the height, thereby interrupting the back scrubbing operation.

d) There are multiple scrubber brushes and gearboxes that require high torque and power consumption.

e) The lower body parts including legs and feet are not easily scrubbed.

f) They are not as aesthetically pleasing as a normal shower fixture.

g) Some of them are mounted on the shower wall with suction cups. These will make them unsafe to operate with the heavy weight of the apparatus and scrubbing force exerted to the scrubber drive housing.

h) The spray showerheads or liquid soap dispensers are at a fixed position and not height changeable.

i) The scrubber is mounted flat on the scrubber housing and against the wall, thereby, scrubbing underarm, feet or other crevices are not easily scrubbed.

j) The scrubbers are not tilt able.

k) Brushes are used instead of sponges for the scrubber material.

l) None of the scrubbers has a replaceable scrubber pad.

m) None of the scrubbers has a solid soap pocket built in the rotating scrubber.

### SUMMARY OF THE INVENTION

In view of the foregoing disadvantages inherent in the known types of body scrubber, the present invention provides a new motorized body scrubber wherein the same can be utilized for effectively scrubbing the body from neck down to toes without operational interruption. As such, the general purpose of the present invention, which will be described subsequently in greater detail, is to provide a new motorized body scrubber which has many of the advantages of the body scrubber heretofore, and many novel features that result in a body scrubber which is not anticipated, rendered obvious, suggested, or even implied by any of the prior art body scrubbers, either alone, or any combination thereof.

To attain this, the present invention essentially comprises a motorized body scrubber for effectively scrubbing back, side, front of dorsal parts and thighs, legs and feet of a person while taking a shower or bath. The scrubber travels vertically while scrubbing as the user desires.

The body scrubber is comprised of a motorized body scrubber 14 and its drive, a scrubber-traveling rail 20 and a motorized scrubber height changer 32. Said scrubber 14 is made of a sponge material. Said scrubber 14 is contoured such that large or small areas, flat or contoured shapes or crevices, may be scrubbed. Said scrubber 14 has a quick disconnect attachment to the scrubber drive shaft 76. Said scrubber 14 is substantially protruding from the wall surface such that underarms, soles, insteps and other crevices can be scrubbed from a normal standing position by the user. Said scrubber 14 is driven by a drive contained in a water spray proof scrubber housing 16. Said housing 16 is attached to the rail traveler 18. Said scrubber-housing 16 encases a battery operated scrubber drive motor, battery, a gear drive and a normally open maintained contact on-off control switch. Said traveler 18 contains rail-sliding or rolling means such as roller rail guides in its vertical aperture and a belt tension spring 34. Said traveler 18 freely travels on said rail 20. Said rail 20 is a hollow square tubing and mounted vertically in the shower stall wall 10 or the bath wall securely by means of mounting brackets 22 and screws. Said rail 20 contains a non-slip belt 28, an idler pulley 26 on the bottom and a powered drive pulley 24 on the top. A DC battery powered motor and gear drives said pulley 24. The motor, battery and gear drive are encased in a water spray proof housing 32. Said motor is electrically connected by a single electrical cord 54 containing four conductors to a normally open and momentary closed contact 6 pin switch housed in a water spray proof switch box 30. Said switch box 30 is placed in a switch box holder 62 mounted at a conveniently reachable location. Said switch box 30 and said cord 54 are mounted on the shower wall 10 or bath wall by suction cups 64. The user may take said switch box 30 out of its holder 62 and hold it in his/her hand while scrubbing. Said belt 28 is attached to the rail traveler 18, placed around the drive pulley 24, threaded through the aperture of the hollow rail 20, around the idler pulley 26 at the rail bottom and attached to the belt tension spring 34 on the said rail traveler 18, thereby forming a continuous loop. The body scrubber can provide an angle adjustable scrubber as shown in FIGS. 3-3B as an additional embodiment. In addition, the body scrubber can contain a local showerhead 58 and a liquid soap dispenser 60 mounted on the rail traveler 18. Also, said scrubber 14 can have additional replaceable scrubber pads which can form a pocket for a solid soap as illustrated in FIG. 2A.

It is to be understood that the invention is not limited in its application to the details and to the arrangements of the components set forth in the following description or illustrated in the drawings. This invention is capable of other embodiments. Also, it is to be understood that the phrases and terminology employed herein are for the purpose of description and should not be regarded as limiting.

As such, those skilled in the art may readily utilize this invention for designing of other structures, methods and systems for carrying out the purpose of the present invention. Therefore, it is important that the claims will be regarded as including such equivalent concepts, methodologies or constructions insofar as they do not depart from the spirit and scope of the present invention.

### OBJECTS AND ADVANTAGES

Accordingly, besides the advantages over the disadvantages described in the above BACKGROUND—DESCRIPTION OF PRIOR ART, several objects and advantages of this body scrubber are:

a) to provide a body scrubber which is lower in manufacturing cost.

b) to provide a body scrubber that scrubs where the user desires from the neck to the toes.

c) to provide a body scrubber that the scrubber is shaped such that large and small areas with flat or contoured or crevice shapes may be scrubbed by one scrubber.

d) to provide a body scrubber that can be installed in the existing shower stall or bath tub wall without modifications.

e) to provide a body scrubber that the scrubber is made of sponge or similar material which can conform to the body contour better and retains the washing soap longer.

f) to provide a body scrubber that the user can hold the height control switch in hand and operate or it is placed at a convenient location.

g) to provide a body scrubber that the user can change the scrubber height even during scrubbing operation and without turning his/her body.

h) to provide a body scrubber that the user can easily change the scrubber angle for scrubbing or folding for stowage.

i) to provide a body scrubber which can be used by anyone, especially by a disabled person who has difficulty moving arms or bending over.

j) to provide body scrubbing a safe task. There is no need to bend over or strain arm muscles to scrub one's dorsal parts or other lower body parts. This body scrubber may reduce slipping and falling in the shower or bath.

k) to provide a body scrubber that the shower water can be sprayed at different heights without holding a hand held showerhead. The showerhead height can be changed as well as changing the scrubber height.

l) to provide a body scrubber that has an easily replaceable scrubber and a scrubber pad.

m) to provide a body scrubber that the rotating scrubber pad forms a solid soap pocket. It will allow many scrubbing applications without additional soap dispensing.

n) to provide a body scrubber that is aesthetically pleasing.

o) to provide a body scrubber that has less moving parts and is light weight.

p) to provide a body scrubber that has low power consumption yet higher scrubbing torque to perform many scrubbing operations before recharging batteries.

q) to provide a body scrubber that the scrubber protrudes an adequate distance from the wall surface so that the user can take a normal standing position in the shower stall to scrub underarms, soles and insteps and other crevices of the body.

r) to provide a body scrubber that the scrubber travel railing may be used as a safety holding bar.

s) to provide a body scrubber that the scrubber may be detached and used as a hand held portable scrubber.

Further objects and advantages of the said body scrubber will become apparent from a consideration of the ensuing description and drawings.

### DESCRIPTION OF DRAWING FIGURES

In the drawings, closely related figures have the same number but different alphabetic suffixes.

FIG. 1 shows the overall view of the body scrubber.

FIG. 1A shows the front view of the overall body scrubber.

FIG. 1B shows the side rear view of the pusher body.

FIG. 1C shows the cutout view A-A′ of the body scrubber housing.

FIG. 1D shows the top view of the scrubber drive housing and the rail traveler.

FIGS. 1E-1I show various rail configurations.

FIG. 2 shows the cutout view B-B′ of the scrubber.

FIG. 2A shows the replaceable scrubber pad and soap pocket formed by the scrubber pad.

FIGS. 3, 3A and 3C show various views of the pivotal scrubber housing. For clarity, some obvious components are not shown.

FIG. 4 shows the two-rail configuration.

FIG. 4A shows the cutout view C-C′ of the two rail configuration.

FIGS. 5 and 5A show the height control switch and scrubber control switch wiring details.

FIG. 6 shows a shower spray head and a liquid soap dispenser mounted on the rail traveler.

### REFERENCE NUMERALS IN DRAWINGS

| | | | |
|---|---|---|---|
| 10 | shower stall | 12 | main shower head |
| 13 | water diverter | 14 | scrubber |
| 16 | scrubber drive housing | 18 | rail traveler |
| 20 | rail | 21 | round rail |
| 22 | mounting leg | 24 | drive pulley |
| 26 | idler pulley | 28 | timing belt |
| 30 | height control switch | 32 | height control drive housing |
| 34 | belt tension spring | 36 | lower arm |
| 38 | pole guide roller | 40 | scrubber drive pivot point |
| 42 | scrubber drive shaft | 44 | scrubber back plate |
| 46 | soap | 48 | scrubber pad |
| 50 | soap pocket | 52 | lock tab |
| 54 | connecting wires | 56 | shower water hose |
| 58 | local shower head | 60 | liquid soap dispenser |
| 62 | switch holder | 64 | suction cup |
| 66 | pivot point | 68 | spring/belt bracket |
| 70 | elastic band | 72 | lock knob |
| 74 | upper arm | 76 | drive shaft |

### DESCRIPTION

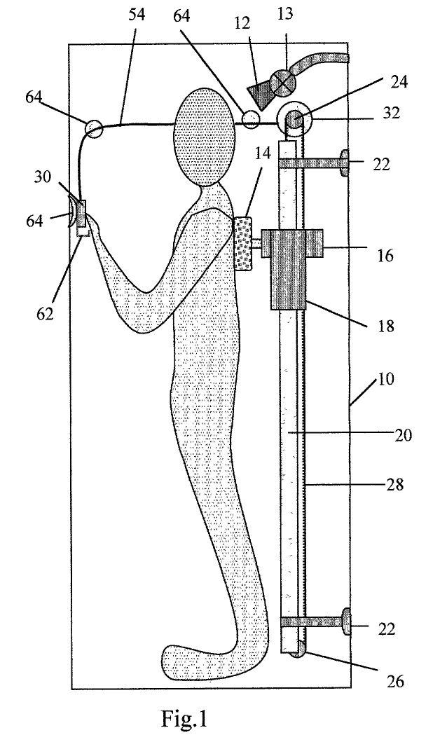

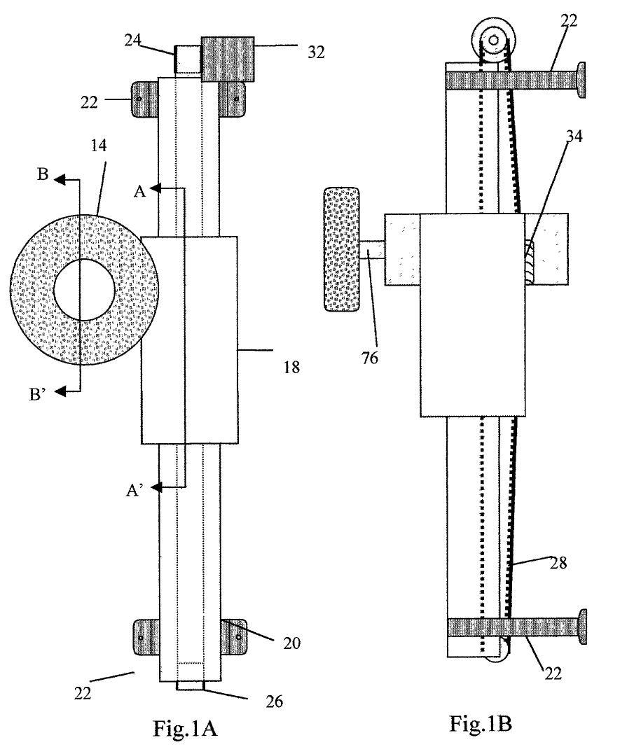

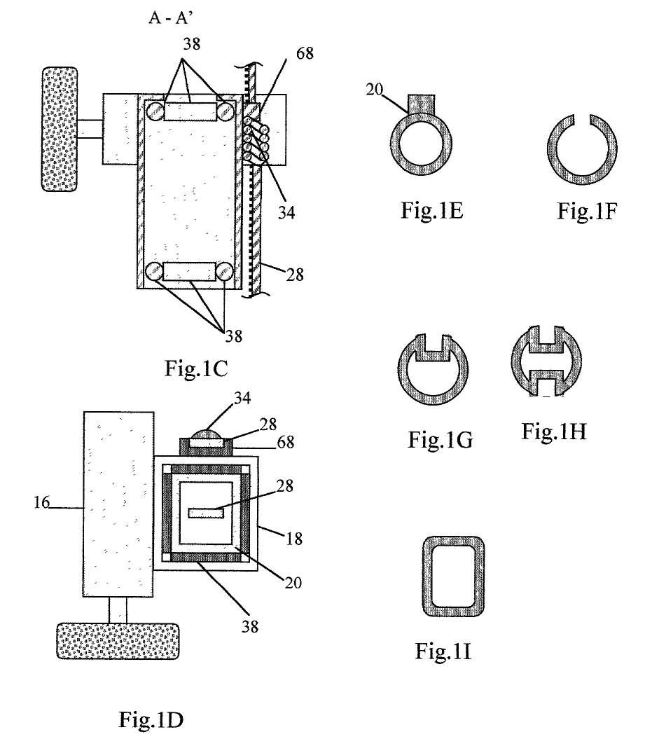

Body Scrubber—FIGS. 1, 1A, 1B, 1C and 1D—Preferred Embodiments

preferred embodiment of the motorized body scrubber of the present invention is illustrated in FIGS. 1, 1A, 1B, 1C and 1D.

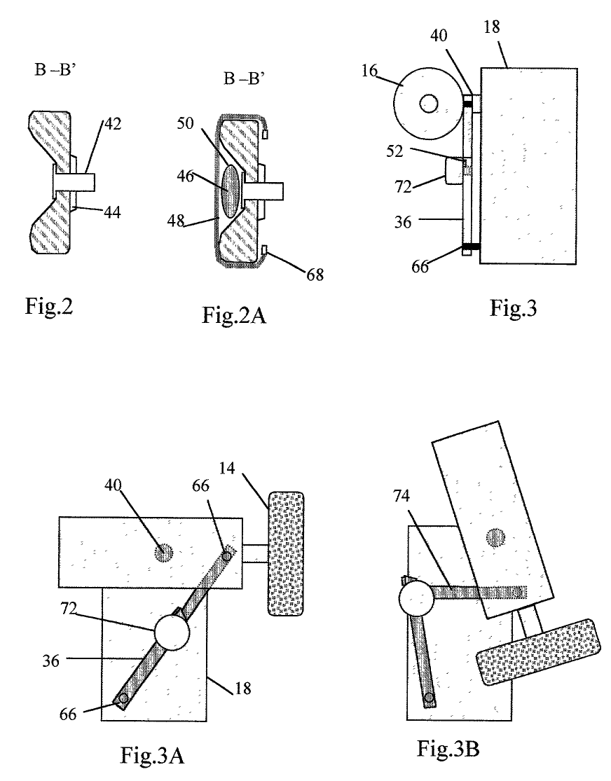

The body body scrubber is comprised of a motorized body scrubber 14, a scrubber-traveling rail 20 and a motorized scrubber height changer 32. Said scrubber 14 is made of a sponge material and its diameter is approx. 5 ″. The scrubber has rounded edges and is shaped thinner around the rotational axis and substantially thicker circumferentially as shown in FIG. 2. Said scrubber has a quick disconnect attachment to the scrubber drive shaft 76. Said scrubber 14 is adequately protruding from the wall surface by about 6 ″ to 12 ″ such that underarm, sole, instep and other crevices can be scrubbed. Said scrubber 14 is rotated at approx. 180 rpm by a drive shaft 76 driven by a motor and gear drive housed in a water spray proof scrubber housing 16 which is attached to the rail traveler 18. Said scrubber-housing 16 contains a battery operated scrubber drive motor, removable and rechargeable battery, a gear drive, a normally open maintained contact 2 -pin on-off control switch. Said traveler 18 is slidably placed on said rail 20 with a vertical aperture for said rail 20. Said traveler 18 contains roller rail guides 38 and a belt tension spring 34 in and on its housing. Said rail 20 is a hollow square tubing and mounted vertically on the shower stall wall 10 or the bath wall securely by means of mounting brackets 22 and screws. Said rail 20 is comprised of a non-slip belt 28, an idler pulley 26 on the bottom and a powered drive pulley 24 on the top. Said pulley 24 is rotated by a DC motor and gear drive powered by a rechargeable battery, which is enclosed in a water spray proof scrubber height changer housing 32 and mounted at the top of the rail 20. Said motor and battery are connected by a electrical cord 54 containing four wire conductors to a normally open and momentary closed contact 6 -pin switch housed in a water spray proof switch box 30. Said box 30 is placed in a switch box holder 62 mounted on the wall 10. Said box 30 and said holder 62 are mounted on the wall by suction cups 64 or the like. The user may take said box 30 out of said holder 62 and hold said box 30 in hand while scrubbing. Said belt 28 is attached to the rail traveler 18 by the bracket 68, placed around the drive pulley 24, threaded through the aperture of the hollow rail 20, around the idler pulley 26 and attached to the belt tension spring 34 which is attached to said bracket 68 mounted on said rail traveler 18, thereby forming a continuous loop. Said scrubber travels vertically at the speed of approx. 14 ′ to 20 ′ per min. Said guides 38 are to move said traveler 18 smoothly on said rail 20. The purposes of the said spring 34 are not only to keep said belt 28 tight around said pulleys 24 and 26 but also to provide enough play on said belt 28 when said traveler 18 is stopped at the rail ends while said height changer drive in said housing 32 is still in motion, therefore, providing a load limiting drive clutch action.

The materials used to construct the housing of the body scrubber and other water spray surfaces can be various. However, due to the shower water use, the material shall resist water spray, wear, stain, mold, corrosion, deformation, temperature, and other elements from the shower water, cleaning chemicals and normal cleaning methods. Stainless steel, anodized aluminum and plastics such as PVC, Polyethylene and Polypropylene are preferred, but not limiting, material.

With a little modifications, commercially available power tools such as hand held screwdrivers or similar which manufactured by Black and Decker or the likes are adapted for the powered drives for the scrubber and the height controller.

FIGS. 2A, 3, 3A, 3B and 6—Additional Embodiments

FIG. 2A shows an easily replaceable scrubber pad 48 held by an elastic band 70 over the scrubber. It also shows the solid soap pocket 50 formed by a scrubber pad 48.

The scrubber and scrubber housing is made angle adjustable and lockable by a lock knob 72 as shown in FIGS. 3-3B.

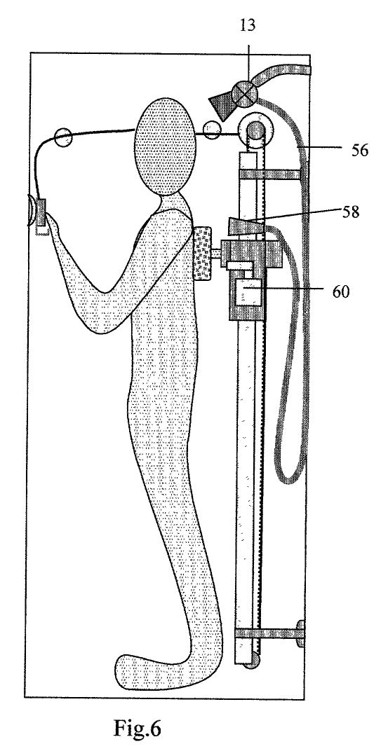

A liquid soap dispenser 60 and a local showerhead 58 are conveniently mounted on said rail traveler 18 as shown in FIG. 6 so that they can travel along with the scrubber. Said soap dispenser 60 is for smearing the scrubber with soap. When rinsing is desired, direct the shower water by turning the diverter valve 13 to the local showerhead 58.

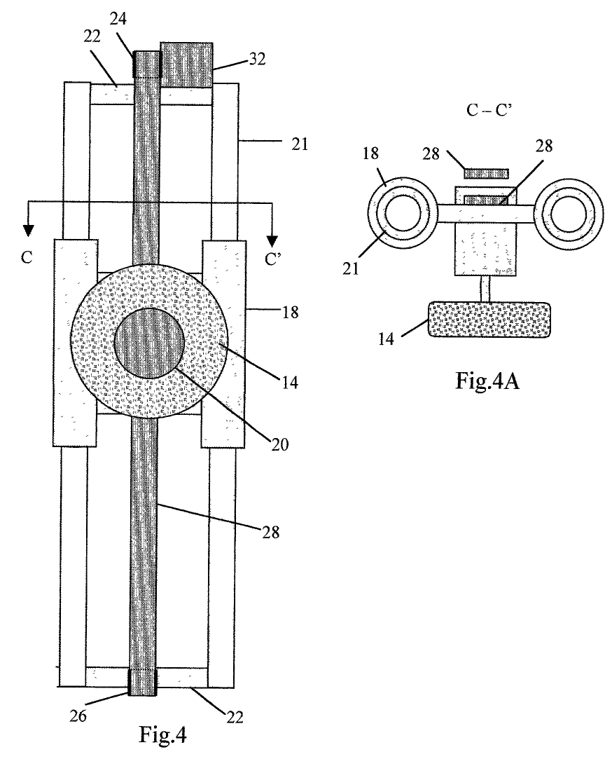

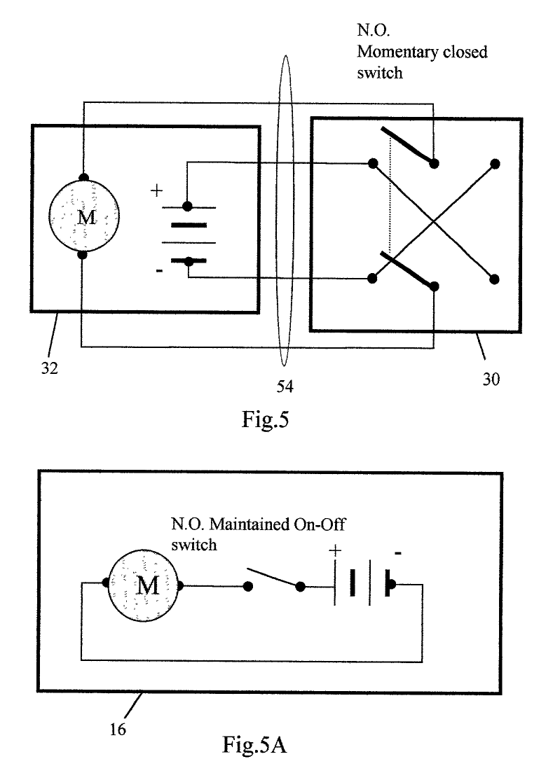

### FIGS. 1E-1I, 4A and 4B—Alternative Embodiments

There are various possibilities with regard to the design of the body scrubber.

FIGS. 4A and 4B show a double pole configuration with round tubing.

FIGS. 1E-1I show other rail design examples.

A plurality of the scrubbers is an alternate embodiment.

The use of low surface friction polymers such as UHMWPE (Ultra High Molecular Weight Polyethylene) and Teflon®, but not limiting, may replace the roller rail guides 38.

The rail may be surfaced with low surface friction materials including, but not limited to, UHMWPE and Teflon®.

The battery for the height controller may be placed in the switch box 30, thereby, reducing the number of conductors in said cord 54. However, this will increase the weight of said switch box 30.

The batteries for the scrubber drive motor and the height changer drive motor can be non-rechargeable disposable type.

Said timing belt 28 and pulleys 24 and 26 used for the scrubber height changing means may be replaced with other non-slip transport mechanism such as timing chains or a worm and gear drive.

The belt tension spring may be made of elastic rubber material.

There may be electrical limit switches for the scrubber height changer travel span on said rail 20.

Both the scrubber and scrubber height changer drives may have load limiting clutches.

The belt tension spring may be placed on the bottom idler pulley or other locations.

Other scrubber sizes are possible.

A radio or infrared wireless remote controls may be employed for one or both of the height and the scrubber controls. A programmable control may be also used.

The scrubber 14 and the motor gear drive housing 16 may be made detachable from the rail traveler 18 for a hand held operation.

### ADVANTAGES

From the aforementioned descriptions, a number of advantages of my body scrubber become evident.

1. The body scrubber is simple, reliable and effective. It can be easily manufactured with a little modification to currently and commercially available battery operated hand tools.

2. The body scrubber can be installed in the existing shower stall or bathtub wall without modifications.

3. The body scrubber uses two independently controlled motorized drives, one for the scrubbing and the other for the height change. Therefore, the scrubbing torque is not affected by the height change drive power consumption.

4. The body scrubber uses a quickly removable scrubber that is shaped such that large or small, flat or contoured shapes or crevices may be scrubbed.

5. The scrubber uses one rotating sponge scrubber, thereby reducing the power requirement for multi gear drives and scrubbers to prolong the battery life before recharging.

6. The body scrubber can change the height at the user's will even during the scrubbing operation without interruption.

7. The body scrubber achieves the scrubber height change by the use of a timing belt and pulleys for light material weight and quite operation and for a low cost production.

8. The user does not need to turn the body to adjust the scrubber height. The height control switch box may be held in the user's hand while scrubbing.

9. The use of this body scrubber will be safer than a manual scrubbing. The user does not need to bend down to scrub lower parts of the body.

10. The scrubber angle is easily adjustable for scrubbing and folding.

11. The user can use the additional height changeable showerhead for rinsing.

12. The body scrubber is electrically safe. The body scrubber will use the low voltage DC powered drive motors with rechargeable and removable batteries. The batteries will be charged remotely outside of the wet area. Or, regular disposable batteries may be used instead.

13. The height control switch does not contain a heavy battery, thereby reducing the weight of the switch box.

14. The body scrubber apparatus will be securely mounted on the wall and will not fall when the suction cups fail as proposed by some prior arts. The scrubber travel rail may be used as a safety rail in the shower stall or bath.

15. The body scrubber is aesthetically pleasing.

16. The body scrubber is easy to clean. The rotating scrubber is easily removable and replaceable.

17. The scrubber pad can be easily replaceable.

18. The scrubber pad forms a solid soap pocket for many scrubbing without additional liquid soap dispensing.

19. The scrubber can be detached for hand held operation.

### OPERATION

Body Scrubber—FIGS. 1, 2A, 3B and 7

The operation is simple. The user will switch on the scrubber head drive in the scrubber housing 16, smear some liquid soap from the soap dispenser 60 conveniently mounted on the rail traveler 18. The user pushes the desired body spot against the rotating scrubber 14. The scrubber height can be changed anytime even during the scrubbing operation by controlling the scrubber height control switch on the switch box 30 for up or down direction. Said switch box 30 is conveniently and remotely mounted on the wall or placed in hand while scrubbing.

When a different scrubber size is desired, remove and replace.

When rinsing is desired, direct the shower water by turning the diverter valve 13 to the local showerhead 58 mounted on the rail traveler 18.

When finished scrubbing, turn off the scrubber drive and return the scrubber to the original height.

The scrubber pad 48 maybe used for washcloth scrubbing. The user may place a solid soap in the soap pocket 50 in the scrubber pad 48 for long and many scrubbing operations.

The user also may want to tilt the scrubber 14 and lock by a locking knob 72 for a desired scrubber angle or folding when not in use as shown in FIG. 3B. The scrubber can be detached from said traveler 18 for hand held operation.

### CONCLUSION, RAMIFICATION, AND SCOPE

Accordingly, the reader will see that the body scrubber of this invention can be used to scrub any spot on the body by remotely changing the scrubber height even when the scrubber is in motion. With this body scrubber, the body scrubbing is made easy, effective, non-strenuous and safe for anybody, especially for disabled. The user is not required to twist arms or bend over to scrub hard to reach areas. The user needs neither to manually adjust the scrubber height nor to turn the body and face the scrubber to do so. The user simply turns on the scrubber and pushes the desired body spot against the rotating scrubber. While scrubbing, the user adjusts the scrubber height by operating the height control switch in hand or on the wall. The scrubber angle can be easily adjustable as desired for scrubbing or off-use. Also, the rail can be used as a safety rail in the shower stall or the bath wall. In addition, when a solid soap is placed in the soap pocket on the scrubber, there is no need for liquid soap.

I claim:

1. A body scrubber comprising of a motorized body scrubber means with a showerhead and a soap dispenser, a scrubber travel means and a motorized scrubber height changer means:

2. A body scrubber in claim 1 wherein the motorized body scrubber means contains at least one scrubber.

3. A body scrubber in claim 2 wherein the scrubber means substantially protrudes from a mounting wall surface.

4. A body scrubber in claim 2 wherein the angle of the scrubber means is adjustable and lockable.

5. A body scrubber in claim 2 wherein the scrubber means is made of a sponge material.

6. A body scrubber in claim 2 wherein the scrubber means is made thinner toward the rotational axis and substantially thicker circumferentially.

7. A body scrubber in claim 2 wherein the scrubber means is covered by a scrubber pad means.

8. A body scrubber in claim 6 wherein the scrubber pad means is made of a washcloth.

9. A body scrubber in claim 6 wherein the scrubber pad means is held by an elastic means on the scrubber means.

10. A body scrubber in claim 6 wherein the scrubber pad means forms a soap pocket.

11. A body scrubber in claim 1 wherein the motorized scrubber means is detachable from the body scrubber apparatus to be used as a hand held motorized scrubber.

12. A body scrubber in claim 1 wherein a showerhead changes height along with the scrubber means.

13. A body scrubber in claim 1 wherein a soap dispenser changes height along with the scrubber means.

14. A body scrubber in claim 1 wherein a motorized body scrubber means travels slidably vertically on one rail means.

15. A body scrubber in claim 14 wherein the rail means has a hollow internal aperture.

16. A body scrubber in claim 14 wherein the scrubber means travels on a rail means on a plurality of roller guide means.

17. A body scrubber in claim 14 wherein the scrubber travel means has a belt tension spring means.

18. A body scrubber in claim 17 wherein the tension spring means is a coil spring type.

19. A body scrubber in claim 17 wherein the tension spring means provides a load limiting slip clutch action.

20. A body scrubber in claim 1 wherein a plurality of the traveling rail means is used.

21. A body scrubber in claim 1 wherein the motorized scrubber height changer means employs the use of non-slip cord and pulley means for changing the scrubber height.

22. A body scrubber in claim 21 wherein the non-slip cord means is a timing belt type.

23. A body scrubber in claim 1 wherein the motorized scrubber height changer means has an external remote control means.

24. A body scrubber in claim 23 wherein a holder is provided for the external remote control means.

25. A body scrubber in claim 23 wherein a plurality of suction cups are used for mounting the holder for the external remote control means and the interconnecting electrical cord means.
